(19) United States
(12) Patent Application Publication
(10) Pub. No.: US 2010/0166635 A1
(43) Pub. Date: Jul. 1, 2010

(54) Interrupted Diamond Growth

(76) Inventor: Chien-Min Sung, Tansui (TW)

Correspondence Address: THORPE NORTH & WESTERN, LLP., P.O. Box 1219, SANDY, UT, 84091-1219, US

(21) Appl. No.: 12/635,983

(22) Filed: Dec. 11, 2009

Related U.S. Application Data
(60) Provisional application No. 61/142,027, filed on Dec. 31, 2008.

(51) Int. Cl. C01B 31/06

(52) U.S. Cl. 423/446

(57) ABSTRACT

A method for growing diamonds under high pressure high temperature (HPHT) is provided. In one aspect, such a method can include providing a growth precursor including a carbon source and a catalyst material, the growth precursor having a diamond precursor particle arranged at least partially therein, melting the diamond precursor particle, and growing a diamond particle by subjecting the melted diamond precursor particle and the growth precursor to temperature and pressure conditions sufficient for diamond growth. In some aspects, the resulting diamond particle can be utilized as a diamond precursor particle in a subsequent reaction to grow an even larger diamond particle.

### PRIORITY DATA

This application claims the benefit of U.S. Provisional Patent Application Ser. No. 61/142,027, filed on Dec. 31, 2008, which is incorporated herein by reference.

### FIELD OF THE INVENTION

The present invention relates generally to methods of synthesizing diamond particles. Accordingly, the present invention involves the fields of chemistry, metallurgy, and materials science.

### BACKGROUND OF THE INVENTION

Diamonds are widely used for both gem quality and superabrasive abrading and cutting applications. The worldwide consumption of diamond particles currently exceeds 400 metric tons. In the area of superabrasive particles, for example, common tools which incorporate superabrasive particles include cutting tools, drill bits, circular saws, grinding wheels, lapping belts, polishing pads, and the like. In general, diamond grits can be classified into three distinct size ranges: coarse mesh saw grits (U.S. mesh 18 to 60 or 1 mm to 0.23 mm) for sawing applications, medium sized grinding grits (U.S. mesh 60 to 400, 230 microns to 37 microns) for grinding applications, and fine powder of micron diamond (U.S. mesh <400 mesh) for polishing applications.

Diamonds are typically formed under ultrahigh pressure, e.g., about 5.5 GPa, and high temperature, e.g., 1300° C. The quality of diamond is typically controlled by the diamond growth rate. Diamond grits are grown by converting graphite to diamond under catalytic action of a molten metal. The molten metal also serves as a solvent of carbon. Catalysts used to synthesize diamond often include iron, nickel, cobalt, manganese or their alloys. The growth rate of diamond is controlled by pressure and temperature. Typically, the lower the over-pressure required to make diamond stable and/or the lower the over-temperature needed to melt the catalyst metal, the slower the growth rate. For example, to grow saw grits in a molten alloy of iron and nickel of Invar composition (Fe65—Ni35), the pressure is about 5.2 GPa and temperature is about 1270° C.

### SUMMARY OF THE INVENTION

The present invention provides diamonds and methods for growing diamonds under high pressure high temperature (HPHT). In one aspect, a method for synthesizing a diamond particle is provided. Such a method can include providing a growth precursor including a carbon source and a catalyst material, the growth precursor having a diamond precursor particle arranged at least partially therein, melting the diamond precursor particle, and growing a diamond particle by subjecting the melted diamond precursor particle and the growth precursor to temperature and pressure conditions sufficient for diamond growth. In some aspects, the resulting diamond particle can be utilized as a diamond precursor particle in a subsequent reaction to grow an even larger diamond particle.

Various methods of melting the diamond precursor particle are contemplated. In one aspect, for example, melting the diamond precursor particle further includes increasing the temperature and pressure conditions subjected to the diamond precursor particle sufficient to melt the diamond precursor particle. In another aspect, melting the diamond precursor particle further includes associating the diamond precursor particle with an additional catalyst material, where the additional catalyst material is present in a quantity sufficient to melt the diamond precursor particle under diamond growth conditions prior to diamond growth. In one specific aspect, associating the diamond precursor particle with the additional catalyst material includes coating the diamond precursor particle with the additional catalyst material. The additional catalyst material can be the same or different from the catalyst material in the growth precursor.

In another aspect of the present invention, a method for synthesizing a diamond particle can include placing a growth precursor including a carbon source and a catalyst material into a reaction vessel, the growth precursor having a diamond seed arranged at least partially therein, subjecting the growth precursor to a temperature and a pressure sufficient for diamond growth to produce a first diamond particle from the diamond seed and the growth precursor, reducing the temperature and the pressure to interrupt growth of the first diamond particle, and adding additional growth precursor to the reaction vessel. The method can additionally include increasing the temperature and pressure to melt the first diamond particle, and growing a second diamond particle by subjecting the melted first diamond particle and the additional growth precursor to temperature and pressure conditions sufficient for diamond growth.

In yet another aspect, a gem quality diamond is provided. Such a gem quality diamond can include a plurality of color zones within the diamond, with each zone having a different color, and wherein there are no inclusion boundaries between the plurality of color zones.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

FIG. 1 is a front view of a diamond particle having associated growth precursor and additional catalyst, according to one embodiment of the present invention.

FIG. 2 is a front view of a melted diamond particle having associated growth precursor and additional catalyst, according to another embodiment of the present invention.

FIG. 3 is a front view of a diamond particle, according to yet another embodiment of the present invention.

FIG. 4 is a front view of a diamond particle having associated growth precursor and additional catalyst, according to a further embodiment of the present invention.

FIG. 5 is a front view of a diamond particle having color zones, according to yet a further embodiment of the present invention.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features, process steps, and materials illustrated herein, and additional applications of the principles of the inventions as illustrated herein, which would occur to one skilled in the relevant art and having possession of this disclosure, are to be considered within the scope of the invention. It should also be understood that terminology employed herein is used for the purpose of describing particular embodiments only and is not intended to be limiting.

### DEFINITIONS

In describing and claiming the present invention, the following terminology will be used.

The singular forms “a,” “an,” and “the” include plural referents unless the context clearly dictates otherwise. Thus, for example, reference to “a catalyst material” includes reference to one or more of such materials, and reference to “an alloy” includes reference to one or more of such alloys.

As used herein, “growth precursor” refers to an assembly of a catalyst material, and a raw material. A growth precursor can further include crystalline or other seeds that can be used for particle growth. A growth precursor describes such an assembly prior to the growth process, i.e. HPHT. Such growth precursors are sometimes referred to as “green bodies.”

As used herein, “inclusion” refers to formation of carbon or metal deposits instead of diamond at the interface between a growth surface of the diamond and the surrounding material. Inclusions are most often formed by the presence of substantial amounts of carbon at the growth surface of the diamond and/or inadequate control of HPHT growth conditions. Similar inclusions and defects can also be formed during cBN synthesis.

As used herein, “heating” refers to introducing heat into a material, whether the temperature of the heated material is increasing or merely maintained during heating. In contrast, “cooling” is a reduction of heating rate, even when heat continues to be introduced, albeit at a lower rate.

As used herein, “alloy” refers to a solid or liquid solution of a metal with a second material, said second material may be a non-metal, such as carbon, a metal, or an alloy which enhances or improves the properties of the metal.

As used herein, “particulate” when used particularly with respect to layers indicates that the layer is formed of particulates. Typically, particulate layers of the present invention can be loose powder, packed powder, or compacted powder having substantially no sintered particles. These particulate layers can be porous or semi-porous compacts. Compacted particulate layers can be formed using any known compaction process such as, but not limited to, wet or dry cold compaction such as cold isostatic pressing, die compacting, rolling, injection molding, slip casting, and the like. The particulate materials used in the present invention such as graphite and metal catalyst powders can be preferably handled and stored in an inert environment in order to prevent oxidation and contamination.

As used herein, “degree of graphitization” refers to the proportion of graphite which has graphene planes having a theoretical spacing of 3.354 angstroms. Thus, a degree of graphitization of 1 indicates that 100% of the graphite has a basal plane separation (d₍₀₀₀₂₎) of graphene planes, i.e. with hexagonal network of carbon atoms, of 3.354 angstroms. A higher degree of graphitization indicates smaller spacing of graphene planes. The degree of graphitization, G, can be calculated using Equation 1.

G=(3.440−d₍₀₀₀₂₎)/(3.440−3.354) (1)

Conversely, d₍₀₀₀₂₎ can be calculated based on G using Equation 2.

d₍₀₀₀₂₎=3.354+0.086(1−G) (2)

Referring to Equation 1, 3.440 angstroms is the spacing of basal planes for amorphous carbon (L_{c}=50 Å), while 3.354 angstroms is the spacing of pure graphite (L_{c}=1000 Å) that may be achievable by sintering graphitizable carbon at 3000° C. for extended periods of time, e.g., 12 hours. A higher degree of graphitization corresponds to larger crystallite sizes, which are characterized by the size of the basal planes (Lₐ) and size of stacking layers (L_{c}). Note that the size parameters are inversely related to the spacing of basal planes. Table 1 shows crystallite properties for several common types of graphite.

TABLE 1

| Graphite | | | | |
|---|---|---|---|---|
| Type | d₍₀₀₂₎ | Lₐ (Å) | L_{c} (Å) | I₁₁₂/I₁₁₀ |
| Natural | 3.355 | 1250 | 375 | 1.3 |
| Low Temp | 3.359 | 645 | 227 | 1.0 |
| (2800° C.) | | | | |
| Electrode | 3.360 | 509 | 184 | 1.0 |
| Spectroscopic | 3.362 | 475 | 145 | 0.6 |
| High Temp | 3.368 | | 400 | 0.9 |
| (3000° C.) | | | | |
| Low Ash | 3.380 | 601 | 180 | 0.8 |
| Poor Natural | 3.43 | 98 | 44 | 0.5 |

As used herein, “predetermined pattern” refers to a non-random pattern that is identified prior to formation of a precursor, and which individually places or locates each crystalline seed in a defined relationship with the other crystalline seeds. For example, “placing diamond seeds in a predetermined pattern” would refer to positioning individual particles at specific non-random and pre-selected positions. Further, such patterns are not limited to uniform grid or offset honeycomb patterns but may include any number of configurations based on the growth conditions and materials used.

As used herein, “uniform grid pattern” refers to a pattern of diamond particles that are evenly spaced from one another in all directions.

As used herein, “crystalline seeds” refer to particles that serve as a starting material for growth of a larger crystalline particle. As used herein, crystalline seeds typically include diamond seeds, cBN seeds, and SiC seeds. For example, growth of superabrasive diamond is commonly achieved using diamond seeds; however cBN and/or SiC seeds can also be used to grow superabrasive diamond.

As used herein, “diamond seeds” refer to particles of either natural or synthetic diamond, super hard crystalline, or polycrystalline substance, or mixture of substances and include but are not limited to diamond, and polycrystalline diamond (PCD). Diamond seeds can be used as a starting material for growing larger diamond crystals and help to avoid random nucleation and growth of diamond.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result. For example, a composition that is “substantially free of” particles would either completely lack particles, or so nearly completely lack particles that the effect would be the same as if it completely lacked particles. In other words, a composition that is “substantially free of” an ingredient or element may still actually contain such item as long as there is no measurable effect thereof.

As used herein, the term “about” is used to provide flexibility to a numerical range endpoint by providing that a given value may be “a little above” or “a little below” the endpoint.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc., as well as 1, 2, 3, 4, and 5, individually. This same principle applies to ranges reciting only one numerical value as a minimum or a maximum. Furthermore, such an interpretation should apply regardless of the breadth of the range or the characteristics being described.

The Invention

It is to be understood that the following description is only exemplary of the principles of the present invention, and should not be viewed as narrowing the appended claims.

The present invention provides techniques for growing diamonds via an interrupted growth mechanism. Such techniques allow both industrial and high quality diamonds to be grown to larger sizes more quickly than has previously been possible. In such a process, at least one diamond particle is placed into a diamond growth chamber with at least the proper growth precursors, namely a carbon source and a catalyst. The diamond particle is then grown under diamond growth conditions to form a larger diamond particle. The process is repeated with the larger diamond particle to produce an even larger diamond particle. Because growth precursor can be added to the diamond growth chamber between each growth cycle, available carbon source remains relatively constant, thus maintaining a more constant pressure during diamond growth, and thus allowing the diamond particle to grow more quickly than with traditional methods. Additionally, diamonds grown with the present techniques can be grown to larger sizes than have been previously possible under HPHT diamond growth methods due to mitigation of many of the problems associated with volume-related pressure decreases. In some aspects of the present invention, the size of the diamond seed(s) or particle(s) used may be about 35 mesh (i.e. 0.5 mm) or greater and the size of final diamond produced may be about 18 mesh (i.e. 1 mm) or greater.

Variations to the interrupted growth process may be utilized for diamonds requiring a high optical quality, such as gem diamonds. Growing a diamond using a series of interrupted growth cycles results in a diamond having one or more visible cores at the boundaries where growth was interrupted. Such a boundary can be eliminated by dissolving the diamond prior to resuming the diamond growth process. Thus the carbon material that is dissolved from the diamond particle is incorporated into the growing diamond during the growth process along with the carbon source that was added during the interruption to form yet a larger diamond. Thus the added carbon source is generally incorporated into the growing diamond on an outer “layer” as would be the case if the diamond particle were not first melted. However, melting the diamond particle prior to growth allows the added carbon source to be more fully integrated into the growing diamond lattice. As such, a visible interface boundary is not formed between the diamond materials. The growth of the diamond can then be interrupted again, additional growth precursor can be added, and the process can be repeated, once again dissolving the diamond prior to diamond growth.

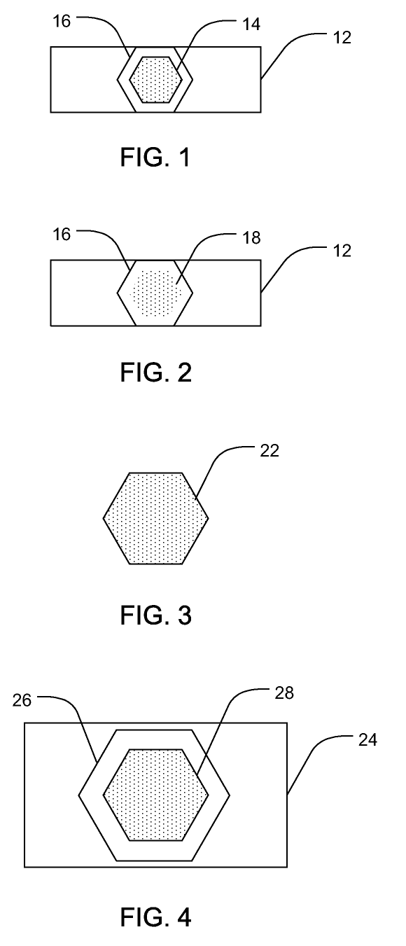

In one aspect, as is partly shown in FIGS. 1-4, the present invention provides a method for synthesizing a diamond particle. Such a method can include providing a growth precursor 12 including a carbon source and a catalyst material, where the growth precursor 12 has a diamond precursor particle 14 arranged at least partially therein. The method can further include melting the diamond precursor particle and growing a diamond particle (22, FIG. 3) by subjecting the melted diamond precursor particle and the growth precursor to temperature and pressure conditions sufficient for diamond growth.

In some aspects the diamond particle can be used as a diamond precursor particle to in order to grow an even larger diamond, as is shown in FIG. 4. In this case, diamond growth can be interrupted, and growth precursor 24 and additional catalyst material 26 can be associated with the diamond precursor particle 28, and diamond growth can be reinitiated as described above.

Various methods are contemplated to dissolve the diamond prior to subsequent growth. In one aspect, for example, the reaction temperature can be increased to equal or exceed the melting temperature of the diamond to facilitate dissolution. The reaction temperature can then be cooled to the proper range to facilitate growth of the diamond. In another aspect, as is shown in FIGS. 1-4, an additional catalyst material 16 can be added to the reaction in close proximity to the diamond. The additional catalyst can be the same type of catalyst material as was included in the growth precursor, or it can be a different type of catalyst material. By associating an additional catalyst with the diamond particle, the diamond will dissolve 18 before diamond growth initiates, as is shown in FIG. 2, thus allowing the elimination of the visible boundaries within the growing diamond.

As has been described, the precursor material includes a carbon source. Under diamond growth conditions, the carbon source can comprise a material such as graphite, amorphous carbon, diamond powder, and the like. In a specific aspect, the carbon source can comprise or consist essentially of graphite. Although a variety of carbon sources can be used, graphite generally provides good crystal growth and improves homogeneity of grown diamond particles. In one aspect, and when graphite is used as the carbon source, the carbon source material can comprise at least about 85 wt % graphite. For embodiments wherein the graphite is formed as a particulate layer, suitable graphite powder can typically be from about 1 μm to about 1 mm.

It has been demonstrated that a higher degree of graphitization can correspond to larger crystallite sizes and improved grown diamond quality and uniformity. Diamond is typically formed through puckering and bending of graphene planes in the presence of molten catalyst metal. Diamond formation can thus be improved by utilizing graphite as a carbon source having a high degree of graphitization. As such, in one aspect, the graphite can have a degree of graphitization of greater than 0.50. In another aspect, the graphite can have a degree of graphitization of from about 0.75 to about 1. In yet another aspect, the degree of graphitization can be greater than about 0.80. In a further aspect, the degree of graphitization can be from about 0.85 to about 1.

In addition to a carbon source, the growth precursor also includes a catalyst material. The catalyst material can comprise any material that is suitable for growth of the diamond particle. Suitable catalyst materials for diamond synthesis can include metal catalyst powder comprising any metal or alloy which has carbon solvent properties, and that is capable of promoting growth of diamond from carbon source materials. Non-limiting examples of suitable metal catalyst materials for diamond growth can include, without limitation, Fe, Ni, Co, Mn, Cr, and alloys thereof. Several common metal catalyst alloys can include Fe—Ni, such as INVAR alloys, Fe—Co, Ni—Mn—Co, and the like. Particularly useful metal catalyst materials include Fe—Ni alloys, such as Fe—35Ni, Fe—31Ni—5Co, Fe—30Ni, and other INVAR alloys, with Fe—35Ni being readily available. Generally, suitable Fe—Ni alloys can have a nickel content that varies from about 10 wt % to about 50 wt %. In addition, the catalyst materials can include various additives that control the growth rate of diamond, such as additives that suppress carbon diffusion, and may also prevent excess nitrogen and/or oxygen from diffusing into the diamond. Suitable additives can include Mg, Ca, Si, Mo, Zr, Ti, V, Nb, Zn, Y, W, Cu, Al, Au, Ag, Pb, B, Ge, In, Sm, and compounds of these materials with C and B.

The arrangement of and forms of materials in the growth precursor can be of any sort that allows for the utilization of interrupted diamond growth methods as are described herein. For example, one or more of the materials used can be a particulate form, and can further optionally be pressed into a layer or plate. The materials can be arranged in alternating or repeating layers, can be homogeneous mixtures, can be specifically arranged and placed within the growth precursor, or can include combinations and variations of the noted arrangements. In one aspect, the catalyst material can also be arranged as a full or partial coating of the diamond precursor particle. In another aspect, the carbon source and catalyst material can be a homogeneous mixture.

In one aspect of the present invention, a diamond precursor particle is disposed at least partially within the growth precursor. A diamond precursor particle is a diamond particle that has been grown under a HPHT process, where that diamond precursor particle will be utilized to grow a larger or a higher quality diamond particle. It should be noted that the term “particle” is not limited by the size of the diamond. Thus diamond particles and diamond precursor particles can include diamonds having a size range of less than 100 microns or greater than 100 microns. In another example, the diamond precursor particle can be greater than 500 microns in size. In another example, the diamond precursor particle can be greater than 1 mm in size. Such particles can also include diamonds greater than 1 carat in size, or greater than 2 carats in size. As such, a diamond precursor particle can include particle sizes that are dependent on the particular HTHP process, and at what point the process has been interrupted for the addition of precursor material. For example, a 100 micron diamond precursor particle can be grown into a diamond particle of about 500 microns in size. That 500 micron diamond particle can then be utilized as a diamond precursor particle to facilitate the growth of a 1 or 2 mm diamond particle, depending on when the grow process was interrupted. The resulting particle can then be utilized as a diamond precursor particle to grow even larger diamond particles.

Additionally, in some aspects precursor particles can be created from diamond seeds. In one aspect, for example, a method for synthesizing a diamond particle can include placing a growth precursor including a carbon source and a catalyst material into a reaction vessel, where the growth precursor has a diamond seed arranged at least partially therein, and subjecting the growth precursor to a temperature and a pressure sufficient for diamond growth to produce a first diamond particle from the diamond seed and the growth precursor. Following growth of the first diamond particle, the temperature and the pressure can be reduced in order to interrupt growth of the first diamond particle. Additional growth precursor can then be added to the reaction vessel, and the temperature and pressure can be increased. The first diamond particle can be melted, and a second diamond particle can be grown by subjecting the melted first diamond particle and the additional growth precursor to temperature and pressure conditions sufficient for diamond growth.

The diamond seed can be any suitable seed material upon which growth can occur for diamond. In one aspect, the diamond seeds can be natural or synthetic diamond seeds. In many cases the diamond seed is a single crystal. Alternatively, the diamond seed can be multi-grained such that a plurality of smaller crystals are bonded together to form each diamond seed. Additionally, it is often beneficial to utilize uncoated diamond seeds, i.e. they do not include additional metal or other coatings around the diamond seed.

It is possible to use a wide variety of diamond seed sizes. For example, in one aspect diamond seeds can have a diameter of from about 30 μm to about 500 μm, and in another aspect from about 55 μm to about 500 μm. In some cases diamond seeds suitable for use in the present invention can be larger than typical diamond seeds, i.e. from about 200 μm to about 500 μm, although the above ranges can also be effectively used. Alternatively, the diamond seeds can have a diameter from about 10 μm to about 50 μm, and in some cases from about 20 μm to about 50 μm.

When more than one diamond precursor particle is used, they can be placed or arranged in the growth precursor randomly or they can be specifically placed. Such placement can include a predetermined pattern, such as, for example, a uniform grid pattern. Placement of the diamond precursor particles can include not only a two-dimensional pattern, but also a three-dimensional pattern as a growth precursor can include a plurality of levels or layers of carbon source and catalyst material with diamond precursor particles at least partially therein.

In some aspects, the growth precursor can also include additional materials. It should be noted, however, that in one aspect, the growth precursor is substantially free of binder, oils, and organic materials. In a similar embodiment, wherein the growth precursor utilizes layers of carbon source and/or layers of catalyst material, the catalyst material can optionally consist essentially of metal catalyst powder, and the carbon source layer can be substantially free of binder, oils, and organic materials. The presence of organic materials during the growth process can cause undesirable flaws and non-uniformities in the grown superabrasive crystal structures in some cases.

In some aspects a binder can be added to the growth precursor to assist in the positioning of the diamond precursor particles. Specifically, in one aspect, a thin layer of binder can be coated over at least a portion of a surface of the growth precursor prior to placement of diamond precursor particles thereon. This can help to prevent the particles from leaving their predetermined positions and further increases ease of handling during manufacture. The layer of adhesive can be formed using any suitable process such as, but not limited to, spraying, film coating, spin coating, extrusion coating, and the like. Spraying is typically convenient and effective in producing a thin and uniform layer of adhesive.

Suitable binders can include, but are not limited to, organic binders such as acrylic adhesives, wax, polyethylene glycol, polyvinyl alcohol, paraffin, naphthalene, polyvinyl butyral, phenolic resin, wax emulsions, and mixtures thereof. The layer of adhesive thus prepared can be of almost any functional thickness. However, as a general guideline, the layer of adhesive can have a thickness from about 1 μm to about 50 μm. The thickness of the layer of adhesive can typically correspond to that which is sufficient to hold the diamond precursor particles or diamond seeds in place. Excessive adhesive can be undesirable in some cases.

As has been described, it may be desirable to minimize organic content in the growth precursor placed in a HPHT apparatus. Specifically, such materials can interfere with particle growth and can be optionally removed during a dewaxing step in order to drive off organic materials. The dewaxing step can preferably be performed using a growth precursor that is substantially complete such that all of the diamond precursor particles are secured within the growth precursor. Securing can be accomplished by stacking adjacent layers or disks of raw material, catalyst material, and/or inert material adjacent the diamond precursor particles. In this way, removal of the organic binders will not disturb the diamond placement.

The desirable ratio of carbon source to catalyst material in the growth precursor can be determined by any methods known in the industry, and is typically dependent on the materials used, arrangement of diamond precursor particles, growing conditions, and efficiency. In one aspect, the catalyst material can be present in amounts and locations sufficient to form a layer of molten catalyst around a growing diamond particle during growth conditions. As a non-limiting example, the carbon source to catalyst ratio can range, in one aspect, from about 0.5 to about 2.0 by weight. It should be noted that additional catalyst can be added around the diamond precursor particle in order to facilitate melting prior to diamond growth initiation. The carbon source and catalyst material can be arranged in any arrangement capable of forming diamond particles. Therefore, particulate layers, homogeneous mixtures, heterogeneous mixtures, combinations and mixtures thereof, and other methods known in the art can be utilized to form diamond particles.

More specifically, although the carbon source is often present in an amount less than about 50 wt %, the amounts of both catalyst and raw material source can vary within that constraint. Specifically, the carbon source can comprise less than about 40 wt %, or further less than about 30 wt %, and still further less than 20 wt %. Additionally, the carbon source can be present in quantities greater than 2 wt %, greater than 5 wt %, greater than 10 wt %, greater than 15 wt %, greater than 20 wt %, and greater than 30 wt %. The noted constraints on the amount of carbon source in the growth precursor can be stated as combinations of the upper and lower boundaries for example, from 5 wt % to 20 wt %, from 20 wt % to 30 wt %, etc. The growth precursor should have catalyst sufficient to substantially envelope the growing diamond and thus allow particle growth. The carbon source can be present so as to dissolve in the molten catalyst (when conditions of processing cause the catalyst to be in a molten state) and precipitate out to grow the diamond particle.

Typical HPHT reaction cells can have a reaction volume of from about 15 cm³ to about 100 cm³. Therefore, it is often practical to include more than one diamond seed or diamond precursor particle in the growth precursor in order to fully utilize available reaction volume for diamond growth. To better utilize the reaction volume, the particles can be placed in a predetermined pattern using any number of methods. Those of ordinary skill in the art will recognize a variety of ways for locating particles at desired locations on a surface or substrate. A number of techniques have been developed for placing particles in a pattern for production of abrasive tools. For example, U.S. Pat. Nos. 2,876,086; 4,680,199; 4,925,457; 5,380,390; and 6,286,498, each of which is incorporated by reference, disclose methods of placing superabrasive particles in a pattern for forming various abrasive tools.

Additional methods to arrange particles into a predetermined pattern known in the art include using an adhesive transfer sheet, using a vacuum chuck, screen printing, lithographic techniques, and the like. It should be noted that when arranging particles in the growth precursor, the particles can be partially or completely encompassed by the growth precursor. Further, it may be useful in some aspects to coat the particles with a material such as a catalyst material. Non-limiting examples of coating catalyst materials used with diamond particles include, e.g., Fe, Ni, Co, and alloys thereof. The coating can typically have a thickness which varies from about 2 μm to about 50 μm, although thickness above this range can also be used.

Once formed, the growth precursor can then be subjected to a temperature and pressure in which diamond is thermodynamically stable. As the temperature and pressure are increased to sufficient growth conditions, carbon from the carbon source migrates toward the diamond precursor particle (or the diamond seed). The catalyst material surrounding individual diamond precursor particles form a catalyst layer substantially surrounding each particle, assuming sufficient catalyst material is present to form such a coating. The catalyst coating thus facilitates formation of diamond. The growth conditions are maintained for a predetermined period of time to achieve a specific size of grown diamond particle.

During diamond growth, if the diamond precursor particle contacts the carbon source, diamond is not formed, and graphite and/or metal will be trapped as inclusions. Consequently, it is important that the diamond precursor particle or seed be enveloped in a molten layer of catalyst to allow uninterrupted growth of diamond. For example, diamond surface area is proportional to the square of the diamond size. Additionally, the supply of catalyst is proportional to the size of the growing diamond. As such, the thickness of the catalyst coating can gradually decrease as the diamond becomes larger. Thus, in aspects where the carbon source and the catalyst material are a substantially homogeneous mixture, such mixture can provide a relatively uniform supply of additional catalyst material which can maintain a sufficiently thick catalyst coating around the growing diamond. Thus, both carbon source and catalyst material tend to diffuse toward the growing diamond. Maintaining a substantially continuous catalyst envelope around each growing crystal helps to significantly reduce the number of inclusions in the grown diamonds.

Pressure and temperature conditions that can be used to grow diamond materials are known in the art. Typical growth conditions can vary somewhat; however, in one aspect the temperature can be from about 1200° C. to about 1400° C. and the pressure can be from about 4 to about 7 GPa. The appropriate temperature can depend on the catalyst material chosen. As a general guideline, the temperature can be from about 10° C. to about 200° C. above a melting point of the catalyst. Growth time between interruptions can typically be from about 5 minutes to about 2 hours.

In addition to the above considerations, the inclusion level can be further reduced by removing contaminants (e.g. oxygen on the metal, moisture in the graphite) from the reaction cells. One effective way to remove such contaminants is to subject the growth precursor, catalyst materials, impurity and/or raw materials to a high vacuum (e.g. 10⁻¹ Pa) at high temperature (e.g. 1100° C.) for an extended period of time (e.g. 2 hours). During this heat treatment, hydrogen can be used to purge the materials to further remove oxygen. Once these contaminants are substantially removed, the grown diamond can be highly transparent with a minimal level of inclusions.

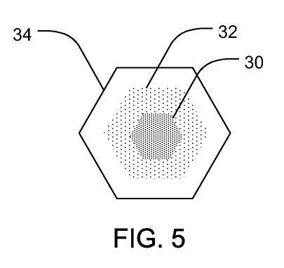

Interestingly, it should be noted that certain impurities can add color to the diamond. For example, boron-doped diamonds are blue, nitrogen-doped diamonds are yellow, titanium-doped diamonds are colorless, etc. Specifically, in some cases blue colored diamonds can be grown by doping the catalyst with boron. Yellow diamonds can be grown by doping the diamond with nitrogen from the air in the reaction chamber. Colorless diamonds can be grown by doping the catalyst with titanium. Diamonds can thus be created having imbedded zones of color within the diamond particle, depending on the type and degree of doping. Because the interrupted diamond growth processes eliminates visible boundaries between these zones of colors, interesting visual colorations can be created. For example, FIG. 5 shows a diamond having two doped zones 30, 32, and one undoped zone 34, where there are no visible inclusion boundaries between the zones.

### EXAMPLES

### Example 1

35/40 mesh diamond particles of high quality are supported by an uprising stream of nitrogen gas inside a funnel. The nitrogen gas is heated to about 50° C. and then pumped in from the bottom of the funnel. A slurry containing invar powder (about 325/400 mesh) is sprayed from the top of the funnel and onto the suspended diamond particles to coat the diamond particles with the invar powder. The coating on the diamond particles is dried, and the slurry is again applied. This repeated drying and coating process is continued with the diamond particles being suspended in the nitrogen stream until the thickness of the dried slurry reaches about one half of the diamond particle size. The dried slurry coated diamond particles are then removed from the coating machine.

While the diamond particles are coated with invar powder, purified graphite powder is mixed with carbonyl made nickel (about 6 microns in size, about 10 V %) in a tubular mixer. The powder is mixed with a binder and a thinner to form a growth precursor slurry that is spraying dried to form granulated particles (about half of a millimeter).

The invar powder coated diamond particles are then mixed with granulated graphite/nickel powder in such a way that, on average, diamond to diamond distance is about four times that of the diamond size. The blend is then compacted by cold pressing (or cold isostatic pressing). This compacted charge is then heat treated under hydrogen at 1000 C for 2 hours to eliminate all non carbon and non metal volatiles (e.g. water, binder, CO2 . . . etc). The purified charge is then compacted under nitrogen to form a cylindrical charge (40 mm in diameter by 30 mm in height) that can be pressed in a cubic press.

The charge is compressed to about 5.2 GPa and heated to about 1300° C. After the melting of the invar that envelopes the diamond particles, each diamond will dissolve in the molten catalyst. Subsequently, the liquid becomes supersaturated by the dissolution of graphite from surrounding materials. The dissolved diamond will then grow. Temperature may be turned down (e.g. 50 C) to slow the grow rate so that inclusions in the diamonds may be minimized After one hour of growth, each diamond is more than doubled in size so the weight increase by about 10 times.

### Example 2

35/40 diamond particles are arranged in a grid pattern by a template that is adhered to a tape. After peeling off the tape with adhered diamonds, another template with holes three times larger than the diamond particles is alighted to and stuck on the tape such that the diamond particles are aligned in the holes. With the tape on the bottom, invar powder (325/400 mesh) is sprinkled on the template to fill in the holes. A scraper is then used to remove the excess invar powder. In this case, only powder filling the hole surrounding diamond remains. The template is carefully removed, leaving diamond particles surrounded by invar powder with spacing about 4× the diamond size. A mixture of graphite and carbonyl nickel is then added. These materials are then cold pressed to form a layer with diamond and invar at the bottom. Many of these layers are stacked up and heat treated as described in Example 1. The heat treated stack is then compressed to consolidate, and then cored to form cylinders. These cylinders are pressed in cubic press as in Example 1.

### Example 3

This example is the same as either Example 1 or Example 2, with the exception that the starting diamond particles are 1 mm in size.

### Example 4

This example is the same as any of Examples 1, 2, or 3, with the exception that the diamond seeds are pre-coated with either Ni, Co, Invar, or Cu, or a mixture thereof.

Thus, there is disclosed a method for synthesizing superabrasive particles having a preselected morphology, and related growth precursors. The above description and examples are intended only to illustrate certain potential embodiments of this invention. It will be readily understood by those skilled in the art that the present invention is susceptible of a broad utility and applications. Many embodiments and adaptations of the present invention other than those herein described, as well as many variations, modifications and equivalent arrangements will be apparent from or reasonably suggested by the present invention and the forgoing description thereof without departing from the substance or scope of the present invention. Accordingly, while the present invention has been described herein in detail in relation to its preferred embodiment, it is to be understood that this disclosure is only illustrative and exemplary of the present invention and is made merely for purpose of providing a full and enabling disclosure of the invention. The foregoing disclosure is not intended or to be construed to limit the present invention or otherwise to exclude any such other embodiment, adaptations, variations, modifications and equivalent arrangements, the present invention being limited only by the claims appended hereto and the equivalents thereof.

What is claimed is:

1. A method for synthesizing a diamond particle, comprising:
providing a growth precursor including a carbon source and a catalyst material, the growth precursor having a diamond precursor particle arranged at least partially therein;
melting the diamond precursor particle; and
growing a diamond particle by subjecting the melted diamond precursor particle and the growth precursor to temperature and pressure conditions sufficient for diamond growth.

2. The method of claim 1, wherein melting the diamond precursor particle further includes:
associating the diamond precursor particle with an additional catalyst material, wherein the additional catalyst material is present in a quantity sufficient to melt the diamond precursor particle under diamond growth conditions prior to diamond growth.

3. The method of claim 2, wherein associating the diamond precursor particle with the additional catalyst material includes coating the diamond precursor particle with the additional catalyst material.

4. The method of claim 2, wherein the additional catalyst material is the same material as the catalyst material.

5. The method of claim 1, wherein melting the diamond precursor particle further includes increasing the temperature and pressure conditions subjected to the diamond precursor particle sufficient to melt the diamond precursor particle.

6. The method of claim 1, wherein the carbon source is selected from the group consisting of graphite, diamond powder, or combinations thereof.

7. The method of claim 1, wherein the diamond precursor particle is greater than 100 microns in size.

8. The method of claim 1, wherein the diamond precursor particle is greater than 500 microns in size.

9. The method of claim 1, wherein the diamond precursor particle is greater than 1 mm in size.

10. The method of claim 1, wherein the diamond particle is used as a diamond precursor particle for a subsequent diamond growth reaction.

11. The method of claim 1, wherein growing the diamond particle further includes doping the diamond particle with a primary doping agent, wherein the primary doping agent is spatially incorporated into the diamond particle with the carbon source of the growth precursor.

12. The method of claim 11, wherein the diamond particle is used as a diamond precursor particle for a subsequent diamond growth reaction, and a subsequent growing diamond particle is doped with a secondary doping agent that is different from the primary doping agent, and wherein the secondary doping agent is spatially incorporated into the subsequent diamond particle with the carbon source of the growth precursor for the subsequent diamond growth reaction.

13. A method for synthesizing a diamond particle, comprising:
placing a growth precursor including a carbon source and a catalyst material into a reaction vessel, the growth precursor having a diamond seed arranged at least partially therein;
subjecting the growth precursor to a temperature and a pressure sufficient for diamond growth to produce a first diamond particle from the diamond seed and the growth precursor;
reducing the temperature and the pressure to interrupt growth of the first diamond particle;
adding additional growth precursor to the reaction vessel;
increasing the temperature and pressure to melt the first diamond particle; and
growing a second diamond particle by subjecting the melted first diamond particle and the additional growth precursor to temperature and pressure conditions sufficient for diamond growth.

14. The method of claim 13, wherein melting the first diamond particle further includes:
associating the first diamond particle with an additional catalyst material, wherein the additional catalyst material is present in a quantity sufficient to melt the first diamond particle under diamond growth conditions prior to diamond growth.

15. The method of claim 14, wherein associating the first diamond particle with the additional catalyst material includes coating the first diamond particle with the additional catalyst material.

16. The method of claim 13, wherein melting the first diamond particle further includes increasing the temperature and pressure conditions of the first diamond particle sufficient to melt the first diamond particle.

17. The method of claim 13, wherein the first diamond particle is greater than 100 microns in size.

18. The method of claim 13, wherein the first diamond particle is greater than 500 microns in size.

19. The method of claim 13, wherein the first diamond particle is greater than 1 mm in size.

20. A gem quality diamond, comprising:
a plurality of color zones within the diamond, with each zone having a different color, and wherein there are no inclusion boundaries between the plurality of color zones.
